(19) United States
(12) Patent Application Publication
(10) Pub. No.: US 2014/0358489 A1
(43) Pub. Date: Dec. 4, 2014

(54) NON-LINEAR PARAMETER MEASURING METHOD AND SYSTEM STRONG TO NOISE

(71) Applicant: Research & Business Foundation SUNGKYUNKWAN UNIVERSITY, Suwon-si (KR)

(72) Inventors: To KANG, Suwon-si (KR); Hunhee KIM, Suwon-si (KR); Hak Joon KIM, Hwaseong-si (KR); Taek Gyu LEE, Suwon-si (KR); Sungjin SONG, Gunpo-si (KR)

(21) Appl. No.: 14/295,416

(22) Filed: Jun. 4, 2014

(30) Foreign Application Priority Data
Jun. 4, 2013 (KR) 10-2013-0064130

(51) Int. Cl. G01N 29/32; G01N 29/24

(52) U.S. Cl. CPC G01N 29/32; G01N 29/2437
USPC 702/191

(57) ABSTRACT

A nonlinearity parameter measuring method and system is configured to separately process a signal of a fundamental wave and second harmonic wave that went through a probe attached to a specimen using a circuit including an analogue band pass filter and intermediate frequency amplifier, and minimize the effects caused by noise, thereby measuring an exact nonlinearity parameter.

### BACKGROUND

1. Field

The following description relates to a nonlinearity parameter measuring method using a piezoelectric receiving method that is strong to noise, and a system thereof, and more particularly, to a nonlinearity parameter measuring method that uses a piezoelectric receiving method wherein noise is removed from a second harmonic wave signal using an analogue band pass filter and intermediate frequency amplifier to minimize the effect of noise included in the second harmonic wave.

2. Description of Related Art

A nondestructive test is conducted to examine whether or not there is a defect in a product and to obtain safety regarding the quality of the product when producing, manufacturing or using the product. For example, it is conducted to find any decay, deterioration, or crack in the product, so as to determine whether or not to further use the product.

According to a nonlinear ultrasonic wave method which is one of the nondestructive test methods, it is possible to measure a displacement of a sound wave and calculate a nonlinearity parameter of a material based on the measured displacement of the sound wave, and evaluate the deterioration degree of the material using the calculated nonlinearity parameter.

A nonlinearity parameter of a metallic material is an intrinsic property of a material, which may be calculated by measuring the size of a sound pressure of a fundamental wave and the size of a sound pressure of a second harmonic wave. And the nonlinear ultrasonic wave method may use a piezoelectric receiving method for measuring the displacement of the sound wave, wherein a probe that is a piezoelectric material is attached to a specimen so as to use a signal being input to the specimen and a signal being output from the specimen.

According to a conventional piezoelectric receiving method, from a signal being output from the specimen, a fundamental wave and a second harmonic wave signal would be measured at the same time and used for calculating a nonlinearity parameter. However, the problem herein is that the size of the second harmonic wave signal is significantly smaller than that of the fundamental wave, and thus when it is mixed with a noise signal, it would be difficult to separate it from the noise signal and measure it.

If the second harmonic wave signal is not amplified big enough to be measured, or not separated from noise, the nonlinearity parameter value calculated may be different from the actual nonlinearity parameter value, or a deviation of the measured value may change at every measurement.

Therefore, there is needed a method capable of measuring an exact nonlinearity parameter with reduced error of measurement.

3. Prior Art

<Patents>

Korean Patent No. 10-0573967 ‘NONDESTRUCTIVE TEST TYPE ULTRASOUND PROBE SYSTEM’

### SUMMARY

Therefore, the purpose of the present disclosure is to resolve the aforementioned problems of prior art, that is, to remove any noise included in a second harmonic signal and remove measurement error so as to obtain an exact measurement value of a nonlinearity parameter.

In a general aspect, there is provided a nonlinearity parameter measuring method including inputting a signal; filtering a signal using a first band pass filter and a second band pass filter that are analogue filters; amplifying the signal that went through the filtering; measuring a voltage of the signal that went through the amplifying; calculating a correction function for a probe; calculating an amplitude; and calculating a nonlinearity parameter.

In the general aspect of the method, the inputting of a signal may involve passing a signal generated in a signal generator through an electric amplifier and low pass filter, successively, and inputting the signal into the specimen, and the amplifier may include a first amplifier and a second amplifier.

In another general aspect, there is provided a nonlinearity parameter measuring system including a signal inputter; a filter including a first band pass filter and a second band pass filter that are analogue filters; a signal amplifier configured to amplify the signal that went through the filter; a voltage measurer configured to measure a voltage of the signal that went through the signal amplifier; a correction function calculator configured to calculate a correction function for a probe; an amplitude calculator; and a nonlinearity parameter calculator.

In the general aspect of the system, the signal inputter may pass a signal generated in a signal generator through an electric amplifier and low pass filter, successively, and input the signal into the specimen, and the signal amplifier may include a first amplifier and a second amplifier.

As aforementioned, using a nonlinearity parameter measuring method and system thereof according to an embodiment of the present invention, it is possible to remove noise included in a second harmonic signal and remove any measurement error so as to obtain an exact measurement value of a nonlinearity parameter.

### BRIEF DESCRIPTION OF THE DRAWINGS

FIG. 1 is a flowchart of a method for measuring a nonlinearity parameter according to an embodiment of the present disclosure.

FIG. 2 is a block diagram of a system for measuring a nonlinearity parameter according to an embodiment of the present disclosure.

FIG. 3 is a circuit diagram of a system for measuring a nonlinearity parameter according to an embodiment of the present disclosure.

FIG. 4 is a circuit diagram for measuring a correction function of a second probe according to an embodiment of the present disclosure.

FIG. 5 is an absolute displacement amplitude graph of a fundamental wave and a second harmonic measured using a signal that passed a digital band pass filter but without an amplifying step by an intermediate frequency amplifier.

FIG. 6 is a graph of nonlinearity parameters calculated using values measured in FIG. 5.

FIG. 7 is an absolute displacement amplitude graph of a fundamental wave and a second harmonic wave measured by a method for measuring a nonlinearity parameter and system thereof according to an embodiment of the present invention.

FIG. 8 is a graph of nonlinearity parameters calculated using a method for measuring a nonlinearity parameter and system thereof according to an embodiment of the present invention.

### DETAILED DESCRIPTION

Hereinbelow, a method for measuring a nonlinearity parameter and a system thereof according to embodiments of the present invention will be explained in detail with reference to the drawings attached hereto.

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

Furthermore, the terms and words used herein and the claims should not be interpreted as limiting to a general or lexical meaning, but should be interpreted as having a meaning and concept that is suitable to the technical concept of the present invention for most suitably expressing the present invention.

A nonlinearity parameter of a metal material is an intrinsic material property that may be calculated based on a measurement of the size of a sound pressure of a fundamental wave and the size of a sound pressure of a second harmonic wave. In order to calculate a nonlinearity parameter, it is necessary to calculate the amplitude of a fundamental wave and second harmonic wave of the signal that passed the specimen.

In order to obtain a variable for calculating the amplitude aforementioned, a signal is input to a test specimen, and then a current and voltage are measured from the signal output. Hereinbelow, a process for calculating the amplitude of a fundamental wave and second harmonic wave component will be explained in detail.

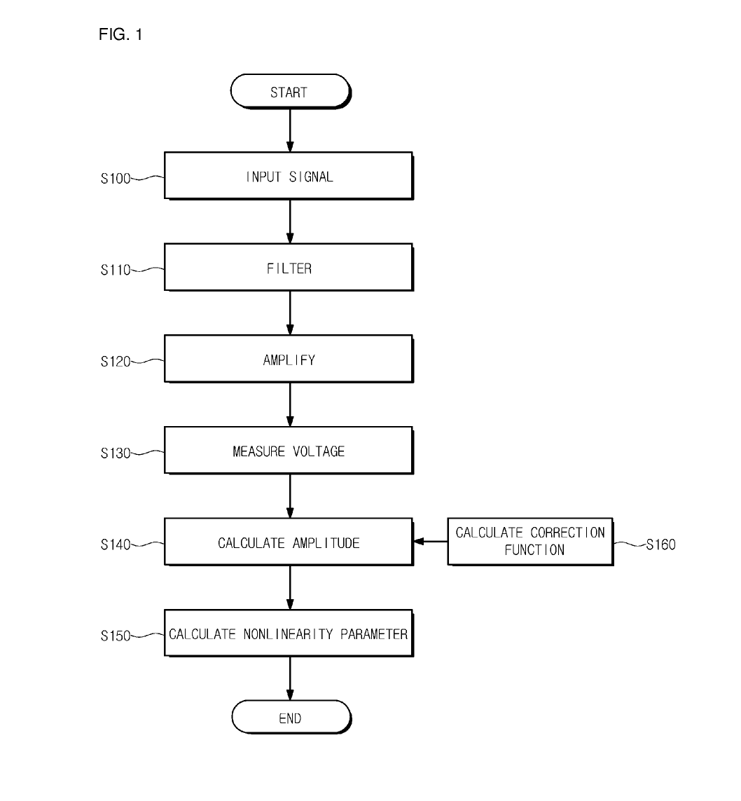

FIG. 1 is a flowchart of a method for measuring a nonlinearity parameter according to an embodiment of the present disclosure.

Referring to FIG. 1, the method for measuring a nonlinearity parameter includes inputting a signal (S100), filtering (S110), amplifying (S120), measuring a voltage (S130), calculating an amplitude (S140), calculating a nonlinearity parameter (S150), and calculating a correction function (S160).

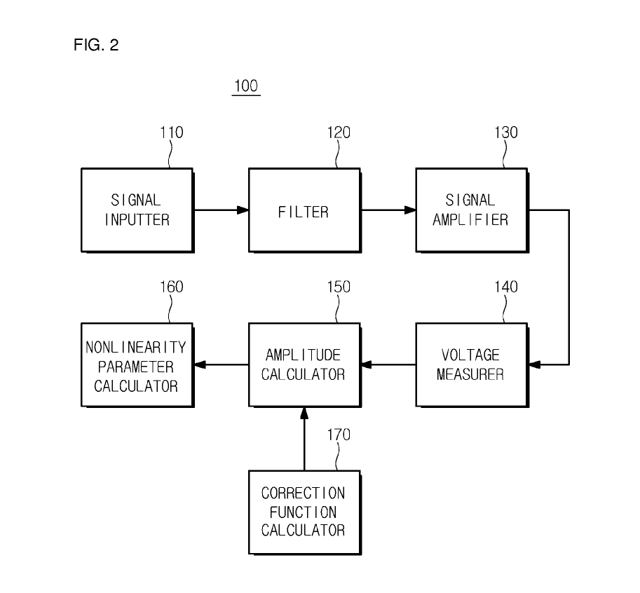

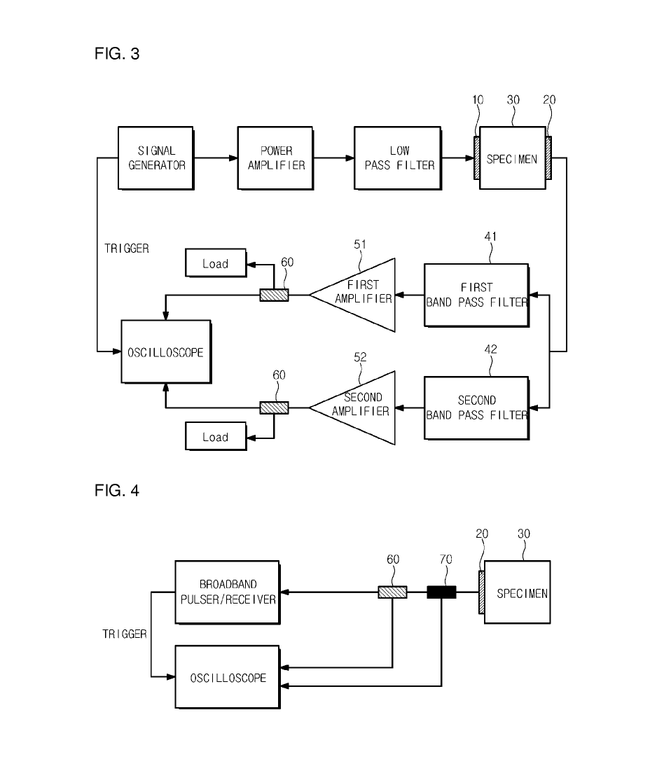

Meanwhile, FIG. 2 is a block diagram of a system for measuring a nonlinearity parameter according to an embodiment of the present invention, and FIG. 3 a circuit diagram of a system for measuring a nonlinearity parameter according to an embodiment of the present disclosure.

Hereinbelow, a method and system for measuring a nonlinearity parameter according to an embodiment of the present invention will be explained in detail with reference to FIGS. 1 to 3.

In the piezoelectric receiving method, a probe 10, 20 that is made of a piezoelectric material is attached to a specimen 30 that is a test subject to measure the size of the sound pressure of a fundamental wave and a second harmonic wave. At the step of inputting a signal (S100), a signal is input into a first probe 10 attached to one end of the specimen.

Referring to FIG. 3, the signal that passed the first probe 10 is input into the specimen, and the signal input into the specimen is then output through a second probe 20 attached to another end of the specimen. Herein, the signal input into the first probe 10 has a certain frequency value, and supposing the frequency of the input signal is f, the first probe 10 is also made of a piezoelectric material having the frequency of f, thereby preventing any distortion from occurring.

Meanwhile, at the step of inputting a signal (S100), the signal generated in the signal generator is passed through an electric amplifier and low pass filter, successively, and then a signal having the fundamental frequency of f is input into the first probe 10.

When the input signal having the frequency of f passes the specimen and arrives at the second probe 20, the input signal will have harmonic wave components besides the fundamental wave due to damage such as deterioration inside the specimen, and the signal that output through the second probe 20 will have frequencies f and 2f components.

Furthermore, at the step of filtering (S110), the signal output from the second probe 20 is filtered, wherein the fundamental component and the second harmonic wave component are filtered basically using a band pass filter.

In the method for measuring a nonlinearity parameter according to an embodiment of the present invention, at the step of filtering (S110), a first band pass filter is used to filter the fundamental frequency f and a second band pass filter is used to filter the second harmonic wave 2f.

Meanwhile, a digital filter may be used as the first and second band pass filter, but in the method for measuring a nonlinearity parameter according to an embodiment of the present invention, an analogue filter is used.

Since it is important to differentiate between the second harmonic wave and noise in measuring a nonlinearity parameter, it is desirable to use an analogue filter having good THD (Total Harmonic Distortion) characteristics.

Furthermore, in the case of using a digital filter, an A/D Converter and D/A converter, and further, a DSP (Digital Signal Process) device must be provided, thereby complicating the configuration, and generating unexpected noise that interrupts the process of signal conversion consisting of numerous steps.

Therefore, when measuring a nonlinearity parameter using a second harmonic wave with a signal size as small as a noise signal, it is more helpful to use an analogue filter than a digital filter for exact measurement and calculation.

At the step of amplifying (S120), the signal that passed the step of filtering (S110) is amplified to enable easy measurement at the step of measuring a voltage (S130) to be followed.

In general, a second harmonic wave has a small signal size and is not easily differentiated from noise, and thus it is advantageous to filter and amplify the second harmonic wave and then measure the signal to calculate an exact nonlinearity parameter.

In a conventional nonlinearity parameter measuring method, the currents of fundamental wave and harmonic wave components are measured at the same time from the signal output from a piezoelectric material attached to a test specimen, but herein it is difficult to detect the harmonic wave signal that has an extremely small size compared to the fundamental wave, and it is also difficult to differentiate it from noise. Therefore, such a method cannot be used in calculating an exact nonlinearity parameter.

According to an embodiment of the present invention, the fundamental wave and second wave components are filtered using a first and second band pass filter. Then the filtered signal is amplified so that an exact second harmonic wave signal can be measured.

Meanwhile, at the step of amplifying (S120), an IF Amp (Intermediate Frequency Amplifier) is used to amplify the signals that passed the first and second bad pass filter based on frequency f and frequency 2f, respectively.

The IF Amp is effective in improving the selectivity and sensitivity of a signal and providing a signal having a size that is suitable for measurement at the next step.

Furthermore, at the step of measuring a voltage (S130), the voltage of the amplified signal is measured using a voltage probe 60 that is connected to an output end of the first and second amplifiers 51, 52, and then the voltage measured is used in calculating an amplitude at the next step.

At the step of calculating an amplitude (S140), the amplitude of the fundamental component and the amplitude of the second harmonic wave are calculated using the formulas shown below.

$${A}_{inc} ( {ω}_{1} ) = \frac{\vert H ( ω ) \vert * \vert {V}_{out} ( {ω}_{1} ) \vert}{\vert Z ( {ω}_{1} ) \vert} \\ {A}_{inc} ( {ω}_{2} ) = \frac{\vert H ( ω ) \vert * \vert {V}_{out} ( {ω}_{2} ) \vert}{\vert Z ( {ω}_{2} ) \vert} \qquad [ Math formula 1 ]$$

Herein, A_{inc} (w₁) is the amplitude of the fundamental wave and A_{inc} (w₂) is the amplitude of the second harmonic wave; Vₒᵤₜ (w₁) is the voltage of the fundamental wave and Vₒᵤₜ (w₂) is the voltage of the second harmonic wave; Z(w₁) is the impedance of the voltage probe that measures the voltage of the fundamental wave and Z(w₂) is the impedance of the voltage probe that measures the voltage of the second harmonic wave; and H(W) is the correction function for the second probe.

Theoretically, only the harmonic components caused by the material should be considered in measuring a nonlinearity parameter, but in fact, not only the harmonic components caused by the material, but also the harmonic wave components generated by the electric system including a probe are considered in measuring a nonlinearity parameter.

Therefore, the nonlinearity actually measured may be overestimated, and since the size of the harmonic wave generated by the nonlinearity of a material is generally extremely small, it may have a big effect on the measurement results.

H(w), that is the correction function for the second probe, is included for the purpose of minimizing any error of calculation by reflecting the effect by the electric system that includes such a probe in the process of measuring a nonlinearity parameter.

Meanwhile, at the step of calculating a nonlinearity parameter (S150), a nonlinearity parameter of the specimen 30 is calculated through the formula shown below using the amplitudes of the fundamental wave and the second harmonic wave calculated at the step of calculating the amplitude (S140).

$$β = \frac{{A}_{2}}{{A}_{1}^{2}} \qquad [ Math formula 2 ]$$

Herein, A₁ is the absolute displacement amplitude of the fundamental wave, A₂ is the absolute displacement amplitude of the second harmonic wave, and β is the nonlinearity parameter of the specimen.

The absolute displacement amplitude (A₁, A₂) of each signal is the result of an inverse Fourier transformation of A_{inc}(w₁) and A_{inc}(w₂) calculated through math formula 1. Meanwhile, calculating a nonlinearity parameter of a material using math formula 2 aforementioned is limited to when it is possible to fix the wave number and propagation length to a constant number.

At the step of calculating a correction function (S160), the correction function H(w) is calculated that is needed for calculating an amplitude at the step of calculating an amplitude (S140). For the method for calculating the correction function H(w), see the explanation made with reference to FIG. 4 hereinbelow.

Meanwhile, referring to FIG. 2, a nonlinearity parameter measuring system according to an embodiment of the present invention includes a signal inputter 110, filter 120, signal amplifier 130, voltage measurer 140, amplitude calculator 150, nonlinearity parameter calculator 160, and correction function calculator 170, and performs the functions corresponding to the step of inputting a signal (S100), the step of filtering (S110), the step of amplifying (S120), the step of measuring a voltage (S130), the step of calculating an amplitude (S140), the step of calculating a nonlinearity parameter (S150), and the step of calculating a correction function (S160), respectively, of the nonlinearity parameter measuring method.

Therefore, the signal inputter 110 inputs the signal generated from the signal generator into the specimen 30 to which the first probe and the second probe (10, 20) are attached as a signal having fundamental frequency f, and the filter 120 filters the signal being output from the second probe 20. Furthermore, the signal amplifier 130 amplifies the fundamental wave and second harmonic wave filtered in the filter 120, and the voltage measurer 140 measures the voltage of the fundamental wave and second harmonic wave.

Furthermore, the correction function calculator 170 calculates the correction function H(w) regarding the second probe. Meanwhile, the amplitude calculator 150 calculates the amplitude of the fundamental wave and second harmonic wave using the voltage measured in the voltage measurer 140 and the correction function H(w) calculated in the correction function calculator 170.

Lastly, the nonlinearity parameter calculator 160 calculates the nonlinearity parameter of the specimen using the absolute displacement amplitude of the fundamental wave and second harmonic wave that went through the inverse Fourier transformation regarding the amplitude calculated in the amplitude calculator 150.

FIG. 4 is a circuit diagram for measuring a correction function of the second probe according to an embodiment of the present invention.

Referring to FIG. 4, the circuit diagram consists of a broadband pulser/receiver, oscilloscope, voltage and current probe 60, 70, and measures an input/output voltage and current with only the second probe 20 connected to the specimen.

The signal generated from the broadband pulser/receiver passes the second probe 20 and is input into the specimen 30, and then reflected from the opposite side of the specimen, and the voltage and current of the signal reflected from the opposite side of the specimen and then output from the second probe 20 again is measured.

Meanwhile, the correction function H(w) of the second probe is calculated using the math formula shown below.

$$H ( ω ) = \sqrt{\frac{\vert D ( z , ω ) \vert}{2 {ω}^{2} ρ v π {b}^{2} \vert {I}_{out} ( ω ) \vert} \vert {V}_{in} ( ω ) + \frac{{I}_{in} ( ω ) {V}_{out} ( ω )}{{I}_{out} ( ω )} \vert} \qquad [ Math formula 3 ]$$

Herein, ρ is the density of the specimen, b is the radius of the second probe, v is the velocity of the longitudinal wave inside the specimen, D(z,w) is the diffraction correction function, Iᵢₙ(w) and Iₒᵤₜ(w) are the currents of input/output signals of the second probe, and Vᵢₙ(w) and Vₒᵤₜ(w) are the voltages of input/output signals of the second probe.

The diffraction correction function D(z,w) is a function for correcting the effects due to blurring or diffraction of the signal inside the specimen 30, variable z refers to the propagation length of the signal inside the specimen, and represents the efficiency of output to input according to the frequency.

When measuring a nonlinearity parameter of the specimen using a piezoelectric element, the state of connection between the probe and specimen has significant effects on the measurement results, and thus the correction function and the diffraction correction function must be measured every time when measuring a nonlinearity parameter.

Meanwhile, the diffraction correction function may be obtained through math formula 4 shown below.

$$D ( z , ω ) = {\{ 1 - {e}^{- j \frac{ω {a}^{2}}{4 Lc}} [ {J}_{0} ( \frac{ω {a}^{2}}{2 zc} ) + {jJ}_{1} ( \frac{ω {a}^{2}}{2 zc} ) ] \}}^{- 1} \qquad [ Math formula 4 ]$$

Herein, z is the propagation length of the signal, a is the radius of the probe, J₀ and J₁ are 0th and 1^{st} Bessel Functions, c is ultrasonic velocity, and w is the angular frequency.

Hereinbelow is a summary of math formulas 1 to 3.

As aforementioned, in the nonlinearity parameter measuring method and system according to an embodiment of the present invention, the ultimate nonlinearity parameter is calculated through math formula 3, and variables A₁ and A₂ of math formula 3 are calculated through a Fourier Transformation from the amplitude calculated through math formula 1. Furthermore, in order to calculate the amplitude, correction function H(w) of math formula 2 is needed, and diffraction correction function D(z, w) that is the variable for calculating correction function H(w) must be calculated.

The nonlinearity parameter measuring method and system according to an embodiment of the present invention is characterized to use an analogue band pass filter and intermediate frequency amplifier, and this characteristic enables separating the second harmonic wave signal from noise and measuring it exactly, thereby providing an environment for measuring an exact nonlinearity parameter more precisely.

Hereinbelow, the effects of the nonlinearity parameter measuring method and system according to an embodiment of the present invention will be explained in comparison with a piezoelectric receiving system having a different configuration.

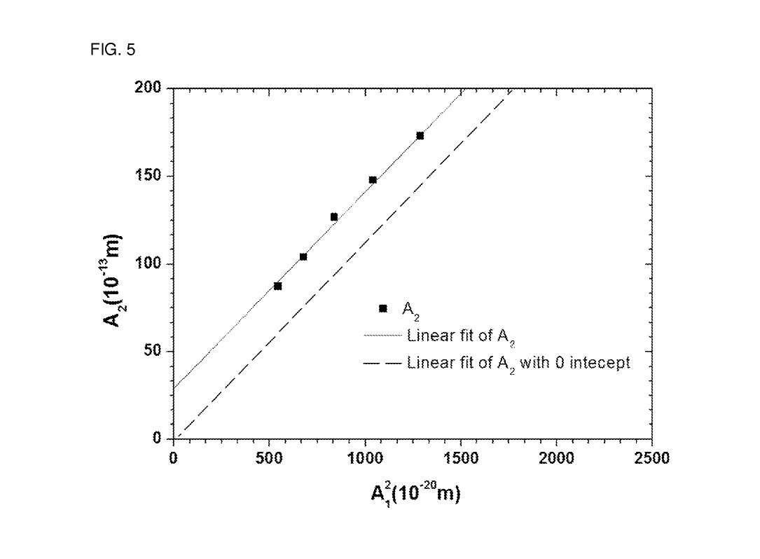

The graph illustrated in FIG. 5 illustrates the absolute displacement amplitude of the fundamental wave and second harmonic wave calculated using a signal output from the second probe attached to the specimen and filtered using not an analogue filter but a digital filter without going through the step of amplifying by an intermediate frequency amplifier.

Referring to FIG. 5, the horizontal axis represents the squared value of the absolute displacement amplitude of the fundamental wave, and the vertical axis represents the absolute displacement amplitude of the second harmonic wave, and the absolute displacement amplitude of each frequency signal is obtained by Fourier transforming A_{inc}(w₁) and A_{inc}(w₂).

The five points illustrated in FIG. 5 represent A₁² and A₂ values calculated through five times of measurement, and the solid line is a straight line of the average values obtained through the five times of measurements. Furthermore, the dotted line is the straight line of the solid line moved to include the zero point.

Referring to FIG. 5, every time a nonlinearity parameter is measured, there occurs an error from the average value, making it difficult to calculate an exact nonlinearity parameter.

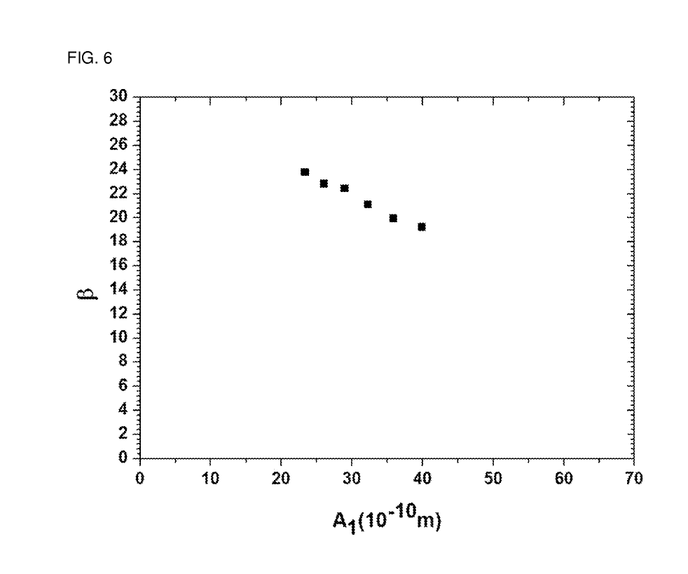

Furthermore, FIG. 6 is a nonlinearity parameter graph calculated using the system of FIG. 5. And from FIG. 5, it can be seen that the calculated nonlinearity parameter differs every time of measurement.

This problem seems to occur because the fundamental wave and second harmonic wave are not measured separately, and thus noise cannot be removed effectively, and due to the additional noise generated in the process of the converting a digital signal, it is impossible to correct the error occurring in the process of Fourier transforming the second harmonic wave signal having a small size.

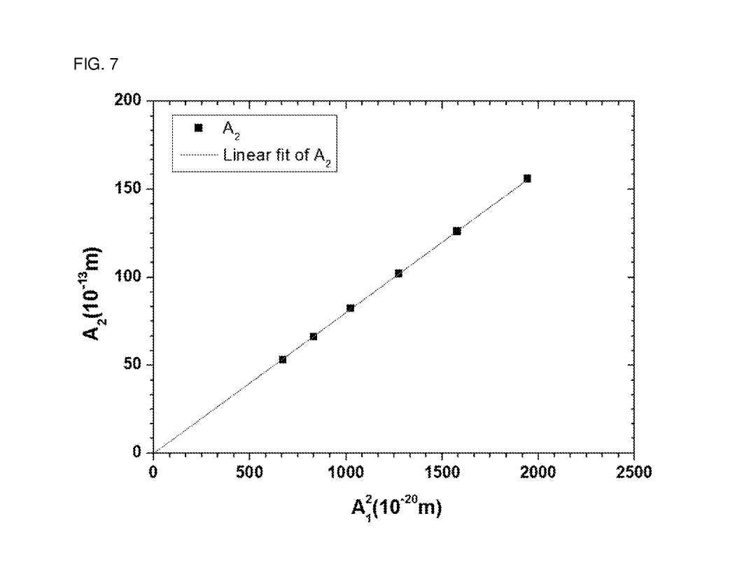

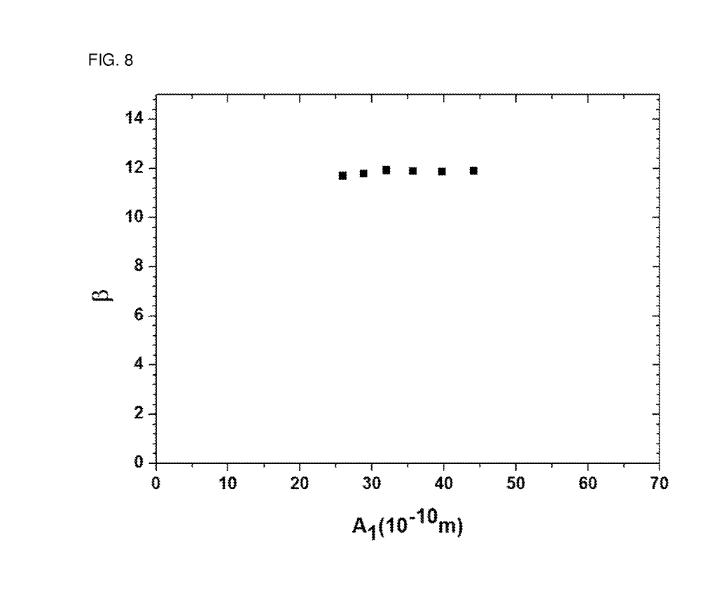

Meanwhile, FIG. 7 illustrates a graph of the absolute displacement amplitude of a fundamental wave and second harmonic wave measured in a nonlinearity parameter measuring method and system according to an embodiment of the present invention, and FIG. 8 illustrates a graph of the nonlinearity parameter measured using a nonlinearity parameter measuring method and system according to an embodiment of the present invention.

Referring to FIG. 7, the ratio of A₁ₗ² and A₂ measured is constant unlike in FIG. 5. Furthermore, referring to FIG. 8, it can be seen that an almost constant nonlinearity parameter is calculated according to the number of times of measurement.

As can be seen from FIGS. 7 and 8, the nonlinearity parameter value calculated by measurement was very close to the actual value with an error rate of 5˜7% only.

As aforementioned, in a nonlinearity parameter measuring method and system according to an embodiment of the present invention, two analogue band pass filters and two intermediate frequency amplifiers are used to process a fundamental wave and second harmonic wave, respectively, and thus a second harmonic wave signal can be differentiated from a noise signal having a similar size, thereby calculating an exact actual nonlinearity parameter.

A number of examples have been described above. Nevertheless, it will be understood that various modifications may be made. For example, suitable results may be achieved if the described techniques are performed in a different order and/or if components in a described system, architecture, device, or circuit are combined in a different matter and/or replaced or supplemented by other components or their equivalents. Accordingly, other implementations are within the scope of the following claims.

What is claimed is:

1. A nonlinearity parameter measuring method comprising:
inputting a signal into a first probe that is connected to one end of a specimen;
filtering a signal being output from a second probe connected to another end of the specimen using a first band pass filter for filtering a fundamental wave and a second band pass filter for filtering a second harmonic wave, the first band pass filter and second band pass filter made of analogue filters;
amplifying the signal that went through the filtering using a first amplifier connected to an output end of the first band pass filter and configured to amplify the fundamental wave and a second amplifier connected to an output end of the second band pass filter and configured to amplify a second harmonic wave;
measuring a voltage of the signal that went through the amplifying;
calculating a correction function for the second probe;
calculating an amplitude of the fundamental wave and second harmonic wave using the correction function for the second probe calculated at the calculating of a correction function and the voltage calculated at the measuring of a voltage; and
calculating a nonlinearity parameter of the specimen using the amplitude of the fundamental wave and second harmonic wave calculated at the calculating of an amplitude.

2. The method according to claim 1,
wherein the inputting of a signal involves passing a signal generated in a signal generator through an electric amplifier and low pass filter, successively, and inputting the signal into the specimen through the first probe.

3. The method according to claim 1,
wherein the first amplifier and second amplifier are intermediate frequency amplifiers.

4. The method according to claim 1,
wherein the calculating of an amplitude involves calculating an absolute displace amplitude of a fundamental wave component and an absolute displace amplitude of a second harmonic wave component using math formula
$${A}_{inc} ( {ω}_{1} ) = \frac{\vert H ( ω ) \vert * \vert {V}_{out} ( {ω}_{1} ) \vert}{\vert Z ( {ω}_{1} ) \vert}$$
$${A}_{inc} ( {ω}_{2} ) = \frac{\vert H ( ω ) \vert * \vert {V}_{out} ( {ω}_{2} ) \vert}{\vert Z ( {ω}_{2} ) \vert} .$$
A_{inc}(w₁) being an amplitude of the fundamental wave component and A_{inc}(w₂) being an amplitude of the second harmonic wave component, Vₒᵤₜ(w₁) being the voltage of the fundamental wave and Vₒᵤₜ(w₂) being the voltage of the second harmonic wave, Z(w₁) being the impedance of a voltage probe for measuring the voltage of the fundamental wave and Z(w₂) being the impendance of a voltage probe for measuring the voltage of the second harmonic wave, and H(w) being the correction function for the second probe.

5. The method according to claim 4,
wherein the correction function for the second probe is calculated using math formula
$$H ( ω ) = \sqrt{\frac{\vert D ( z , ω ) \vert}{2 {ω}^{2} ρ v π {b}^{2} \vert {I}_{out} ( ω ) \vert} \vert {V}_{in} ( ω ) + \frac{{I}_{in} ( ω ) {V}_{out} ( ω )}{{I}_{out} ( ω )} \vert}$$
ρ being the density of the specimen, b being the radius of the second probe, v being the velocity of a longitudinal wave inside the specimen, D(z,w) being a diffraction correction function, Iᵢₙ(w) being the current of an input signal of the second probe and Iₒᵤₜ(w) being the current of an output signal of the second probe, and Vᵢₙ(w) being the voltage of the input signal of the second probe and Vₒᵤₜ(w) being the voltage of the output signal of the second probe.

6. The method according to claim 1,
wherein the calculating of a nonlinearity parameter involves calculating a nonlinearity parameter of the specimen using math formula
$$β = \frac{{A}_{2}}{{A}_{1}^{2}}$$
A₁ being the absolute displace amplitude of the fundamental wave and A₂ being the absolute displacement amplitude of the second harmonic wave, and β being the nonlinearity parameter of the specimen.

7. The method according to claim 2,
wherein the calculating of a nonlinearity parameter involves calculating a nonlinearity parameter of the specimen using math formula
$$β = \frac{{A}_{2}}{{A}_{1}^{2}}$$
A₁ being the absolute displace amplitude of the fundamental wave and A₂ being the absolute displacement amplitude of the second harmonic wave, and β being the nonlinearity parameter of the specimen.

8. The method according to claim 3,
wherein the calculating of a nonlinearity parameter involves calculating a nonlinearity parameter of the specimen using math formula
$$β = \frac{{A}_{2}}{{A}_{1}^{2}}$$
A₁ being the absolute displace amplitude of the fundamental wave and A₂ being the absolute displacement amplitude of the second harmonic wave, and β being the nonlinearity parameter of the specimen.

9. The method according to claim 4,
wherein the calculating of a nonlinearity parameter involves calculating a nonlinearity parameter of the specimen using math formula
$$β = \frac{{A}_{2}}{{A}_{1}^{2}}$$
A₁ being the absolute displace amplitude of the fundamental wave and A₂ being the absolute displacement amplitude of the second harmonic wave, and β being the nonlinearity parameter of the specimen.

10. The method according to claim 5,
wherein the calculating of a nonlinearity parameter involves calculating a nonlinearity parameter of the specimen using math formula
$$β = \frac{{A}_{2}}{{A}_{1}^{2}}$$
A₁ being the absolute displace amplitude of the fundamental wave and A₂ being the absolute displacement amplitude of the second harmonic wave, and β being the nonlinearity parameter of the specimen.

11. A nonlinearity parameter measuring system comprising:
a signal inputter configured to input a signal into a first probe that is connected to one end of a specimen;
a filter configured to filter a signal being output from a second probe connected to another end of the specimen using a first band pass filter for filtering a fundamental wave and a second band pass filter for filtering a second harmonic wave, the first band pass filter and second band pass filter made of analogue filters;
a signal amplifier configured to amplify the signal that went through the filter using a first amplifier connected to an output end of the first band pass filter and configured to amplify the fundamental wave and a second amplifier connected to an output end of the second band pass filter and configured to amplify the second harmonic wave;
a voltage measurer configured to measure a voltage of the signal that went through the signal amplifier;
a correction function calculator configured to calculate a correction function for the second probe;
an amplitude calculator configured to calculate an amplitude of the fundamental wave and second harmonic wave using the correction function for the second probe calculated by the correction function calculator and the voltage calculated by the voltage measurer; and
a nonlinearity parameter calculator configured to calculate a nonlinearity parameter of the specimen using the amplitude of the fundamental wave and second harmonic wave calculated at the calculating of an amplitude.

12. The system according to claim 11,
wherein the signal inputter passes a signal generated in a signal generator through an electric amplifier and low pass filter, successively, and inputs the signal into the specimen through the first probe.

13. The system according to claim 11,
wherein the first amplifier and second amplifier are intermediate frequency amplifiers.

14. The system according to claim 11,
wherein the correction function calculator calculates the correction function for the second probe using math formula
$$H ( ω ) = \sqrt{\frac{\vert D ( z , ω ) \vert}{2 {ω}^{2} ρ v π {b}^{2} \vert {I}_{out} ( ω ) \vert} \vert {V}_{in} ( ω ) + \frac{{I}_{in} ( ω ) {V}_{out} ( ω )}{{I}_{out} ( ω )} \vert}$$
ρ being the density of the specimen, b being the radius of the second probe, v being the velocity of a longitudinal wave inside the specimen, D(z,w) being a diffraction correction function, Iᵢₙ(w) being the current of an input signal of the second probe and Iₒᵤₜ(w) being the current of an output signal of the second probe, and Vᵢₙ(w) being the voltage of the input signal of the second probe and Vₒᵤₜ(w) being the voltage of the output signal of the second probe.
